(19) United States
(12) Patent Application Publication
(10) Pub. No.: US 2004/0064789 A1
(43) Pub. Date: Apr. 1, 2004

(54) System and method for generating invoices using a markup language

(75) Inventors: Frank Gordon Krausz, Boston, MA (US); John Ruark, Cambridge, MA (US)

Correspondence Address: GREENBERG TRAURIG, P.C., 77 WEST WACKER DRIVE, CHICAGO, IL, 60601-1732, US

(73) Assignee: CSG Systems, Inc., Englewood, CO

(21) Appl. No.: 10/614,584

(22) Filed: Jul. 7, 2003

Related U.S. Application Data
(60) Provisional application No. 60/394,984, filed on Jul. 10, 2002.

(51) Int. Cl. G06F 17/00

(52) U.S. Cl. 715/513

(57) ABSTRACT

A system and method for generating an invoice. An Internet Markup Language (IML) file includes a first set of IML tags defined by a document type definition that are used to select data for inclusion in the invoice and a second set of IML tags defined by the document type definition that are used to specify a layout for the invoice including the selected data. An invoice generating application accesses a database of a service provider to collect data according to the first set of tags and uses the collected data and the second set of tags to generate an invoice output file. The invoice output file may then be provided to an output device to generate the invoice.

### RELATED APPLICATION

This application claims the benefit of U.S. Provisional Patent Application Serial No. 60/394,984 filed Jul. 10, 2002 the disclosure of which is hereby incorporated by reference in its entirety.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

The subject invention relates generally to billing system technology and, more particularly, to a system and method for generating invoices using a markup language.

In the e-commerce community, XML has become a cross-platform data format standard that provides a means to link diverse platforms and legacy systems to allow for inter-company transactions. Since business systems are being enabled to process XML data files, XML is replacing many specialized and proprietary formats as it allows for broad acceptance and expansion as needed. XML enables processing of enhanced data across regions and industry sectors and through a growing number of systems and reporting packages.

For use in connection with e-commerce transactions, an exemplary XML message format may be found in the “Visa Extensible Markup Language (XML) Invoice Specification.” Using the “Visa Extensible Markup Language (XML) Invoice Specification” developers may integrate multiple payment types into their data flow independent of the payment means. Therefore, the “Visa Extensible Markup Language (XML) Invoice Specification” is useful for any system designer seeking a standard and interoperable XML definition for processing invoice data. To this end, the specification contains a comprehensive list of data elements contained in most invoices, including: Buyer/Supplier, Shipping, Tax, Payment, Currency, Discount, and Line Item Detail.

While the “Visa Extensible Markup Language (XML) Invoice Specification” provides a definition for processing invoice data, what is needed is a billing product tool that allows a client to specifying the way the client (e.g., a telecommunications provider) wants the invoices that it sends to its customers to be laid out. In particular, what is desired is a billing product tool that allows the client to select which items of customer data are to be displayed on an invoice, to choose the order in which the data is displayed, and, possibly to display sums of data values, etc. To this end, the billing product tool should also allow for the specification of the geometry of the invoice layout, subject to the inherent limitation that customer data will vary (e.g., a list of one customer's long-distance calls may extend over half a page while another's may take up several pages).

### SUMMARY

In accordance with these and other needs, a system and method for generating invoices using a markup language is hereinafter described. In accordance with this system and method, the specification of an invoice layout may be created by a graphical user interface “GUI” application. The invoice layout specification may then be used by a background business-process application to create actual invoices populated with customer data as well as data common to all customers (e.g., using standard formats for currencies, descriptions of the client's service options, etc.). This layout specification may then be stored in a subset of the XML standard referred to hereinafter as the “Invoice Markup Language” or “IML.”

It will be appreciated that, in practice, the created invoice may be a file in a printer-control language such as PCL or AFP which files provide instructions to high-speed printers that are used to generate the actual invoices. It will also be appreciated that the system and method may be used to generate, not a paper invoice, but an HTML invoice for display on a Web browser, or an XML invoice for transmission, perhaps via the Web, to some system downstream. Even in those cases, where the geometry of the layout is largely or wholly irrelevant, there is value added by the IML formulation of the layout and the associated background process, in the creation of a text stream where the data values associated with the invoice are appropriately ordered and grouped.

A better understanding of the objects, advantages, features, properties and relationships of the system and method will be obtained from the following detailed description and accompanying drawings which set forth illustrative embodiments which are indicative of the various ways in which the principles of the system and method may be employed.

### BRIEF DESCRIPTION OF THE DRAWINGS

For a better understanding of the system and method for creating invoices using a markup language, reference may be had to preferred embodiments shown in the following drawings in which:

FIG. 1 illustrates a block diagram of an exemplary computer system in which the principles of the described system and method may be employed;

FIG. 2 illustrates a data flow diagram of exemplary steps used to generate an invoice output file.

### DETAILED DESCRIPTION

Turning to the figures, wherein like reference numerals refer to like elements, an exemplary system and method for creating invoices using a markup language is illustrated and described. Although not required, the system and method will be described in the general context of computer executable instructions being executed by one or more processing devices such as a personal computer, mainframe computer, personal-digital assistant (“PDA”), cellular telephone, or the like. Generally, the computer executable instructions reside in program modules which may include routines, programs, objects, components, data structures, etc. that perform particular tasks or implement particular abstract data types. In this regard, those skilled in the art will appreciate that the system and method described hereinafter may also be practiced in distributed computing environments where tasks are performed by various processing devices that are linked through a communication network and where program modules may be located in both local and remote memory storage devices associated with such processing devices.

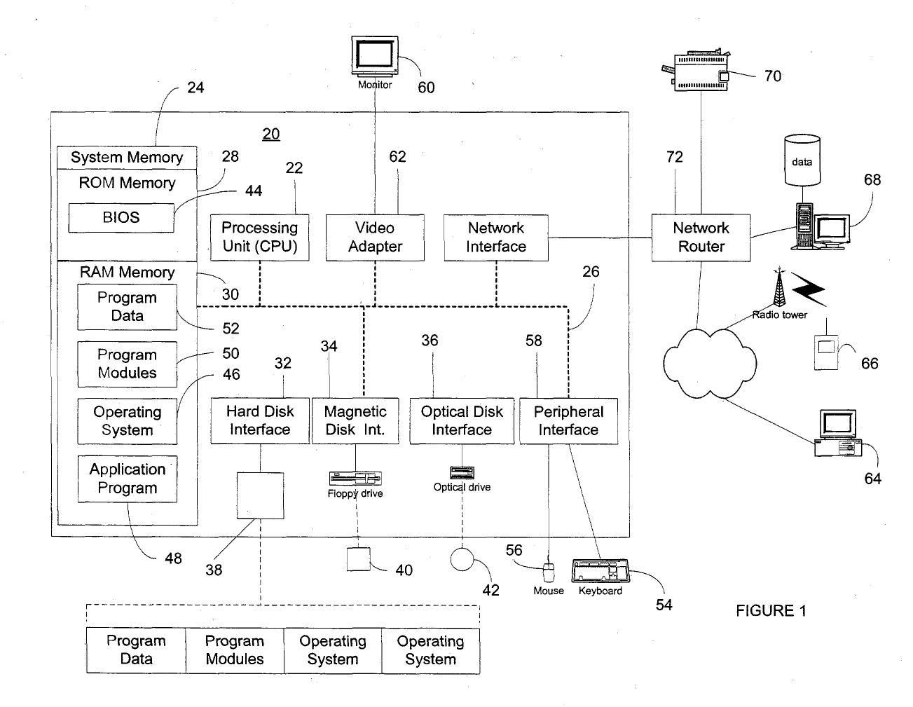

A network system in which the subject system and method may reside is illustrated by way of example in FIG. 1. In the illustrated network system, an invoice generating center 20, illustrated in the exemplary form of a computer system, is provided to create invoices in a manner that will be described in greater detail hereinafter. While described and illustrated as a single computer system, it is again emphasized that the invoice generating center 20 may be implemented such that tasks are performed by various processing devices that are linked through a communication network.

For performing the various tasks, the invoice generating center 20 preferably includes a processing unit 22 and a system memory 24 which may be linked via a bus 26. Without limitation, the bus 26 may be a memory bus, a peripheral bus, and/or a local bus using any of a variety of bus architectures. By way of further example, the bus 26 may include an architecture having a North Bridge and a South Bridge where the North Bridge acts as the connection point for the processing unit 22, memory 24, and the South Bridge. The North Bridge functions to route traffic from these interfaces, and arbitrates and controls access to the memory subsystem from the processing unit 22 and I/O devices. The South Bridge, in its simplest form, integrates various I/O controllers, provides interfaces to peripheral devices and buses, and transfers data to/from the North bridge through either a PCI bus connection in older designs, or a proprietary interconnect in newer chipsets.

As needed for any particular purpose, the system memory 24 may include read only memory (ROM) 28 and/or random access memory (RAM) 30. Additional memory devices may also be made accessible to the invoice generating center 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the invoice generating center 20. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nanodrives, memory sticks, and other read/write and/or read-only memories.

A number of program modules may be stored in one or more of the memory/media devices. For example, a basic input/output system (BIOS) 44, containing the basic routines that help to transfer information between elements within the invoice generating center 20, such as during start-up, may be stored in ROM 24. Similarly, the RAM 30 and/or the hard drive 38 may be used to store computer executable instructions comprising an operating system 46, one or more applications programs 48, other program modules 50, and/or program data 52.

A user may enter commands and information into the invoice generating center 20 through input devices such as a keyboard 54 and/or a pointing device 56. While not illustrated, other input devices may include a microphone, a joystick, a game pad, a scanner, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the invoice generating center 20, a monitor 60 or other type of display device may also be connected to the bus 26 via an interface, such as video adapter 62. In addition to the monitor 60, the invoice generating center 20 may also include other peripheral output devices, not shown, such as speakers and printers.

For operating in a networked environment, the invoice generating center 20 utilizes logical connections to one or more remote processing devices, such as client computer 64, hand-held computer 66 (e.g., a PDA, cell phone, or the like), database computer 68, and/or network printer 70. In this regard, the remote processing devices may include any type of device having processing capabilities and/or the ability to receive communications from the invoice generating center 20. Again, the illustrated processing devices need not be implemented as a single device but may be implemented in a manner such that the tasks performed by the various processing devices are distributed to a plurality of processing devices linked through a communication network Thus, the remote processing devices may include many or all of the elements described above relative to the invoice generating center 20 including the memory storage devices and a display device. The connection between the invoice generating center 20 and the remote processing devices may be made through a further processing device 72 that is responsible for network routing. Furthermore, within such a networked environment, it will be appreciated that program modules depicted relative to the invoice generating center 20, or portions thereof, may be stored in the memory storage devices of the remote devices.

To generate invoices, i.e., print invoices and/or display invoices, acts and symbolic representations of operations will be performed by the processing devices illustrated in FIG. 1. As such, it will be understood that such acts and operations, which are at times referred to as being computer-executed, include the manipulation by the processing devices of electrical signals representing data in a structured form. This manipulation transforms the data or maintains it at locations in the memory system, which reconfigures or otherwise alters the operation of the processing devices 20, 64, 66, 68, and 70 in a manner well understood by those of skill in the art of computer systems. The data structures where data is maintained are physical locations of the memory that have particular properties defined by the format of the data. Nevertheless, while described in the foregoing context, this description is not meant to be limiting as those skilled in the art will further appreciate that various acts and operations described herein may also be implemented in hardware.

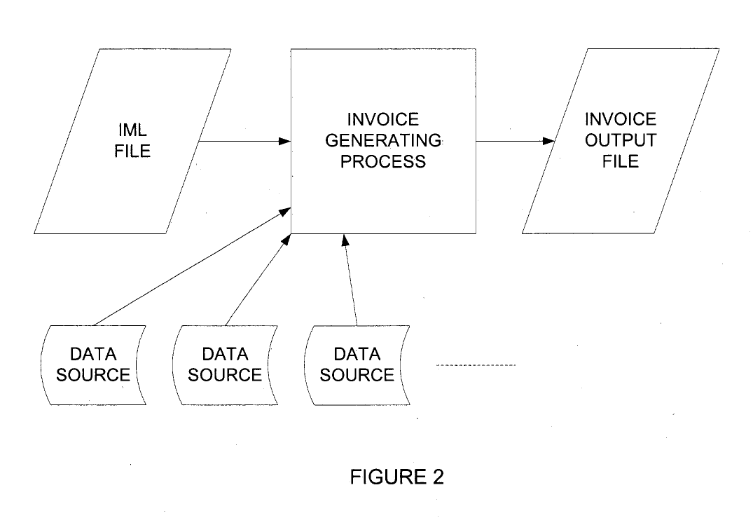

For use in generating invoices, the invoice control center 20 includes programming that creates IML files as well as programming that employs the IML files to generate invoice files. The programming used to create the IML files preferably includes conventional graphical user interface tools that allows a user to specify the layout of an invoice. From the layout specified using the graphical user interface tools, the programming creates an IML file. Since such graphical user interface tools are well understood by those of ordinary skill in the relevant art, they will not be discussed further herein for the sake of brevity. Meanwhile, the invoice generating application, which may be executed as a background process, functions to collect data from a database, such as a customer service database 68, which is then used to create an invoice output file per the requirements of an IML file, as illustrated in FIG. 2. By way of example, the data used to populate the invoice output file may include customer data, such as the name and address of the person being invoiced, the amount due, etc; client data, such as the name of the pricing package that customer has subscribed to, the corporate logo, etc.; and resource data, such as localizable currency formats, fonts available on the printer 70, etc.

The invoice output file may then be used to generate an invoice. For example, the invoice output file may be a file in a printer-control language such as PCL or AFP which files provide instructions to high-speed printers, such as printer 70, that are used to generate the actual invoices. In addition, the invoice output file may be an HTML file for display on a Web browser of a device such as client computer 64 or hand-held device 66. Still further, the invoice output file may be an XML file for transmission, perhaps via the Web, to some system downstream. Even in those cases, where the geometry of the layout is largely or wholly irrelevant, there is value added by the IML formulation of the layout and the associated background process, in the creation of a text stream where the data values associated with the invoice are appropriately ordered and grouped.

More specifically, the IML file created using the GUI application includes several different tags, defined by a document type definition, that function to define the data and the layout of an invoice to be generated. An exemplary document type definition is set forth in Appendix A. In the document type definition, in terms of the data selection, there are filters, which are Boolean-valued functions that are evaluated against the one or more data sources to create what is, in RDBMS terminology, called a data “view” (e.g., in the case of data for all long-distance calls, the filter is a function that would evaluate to “true” if the data represents such a call); there are grouping filters, which partition the rows in a view into subviews (e.g., group all long-distance calls by the different phones the customer used to place them); there are expressions, which are functions evaluated on the data, either explicitly or implicitly (e.g., the cost of a long-distance call, or implicitly, the customer's name); and there are accumulators, which evaluate the sum of an expression over the data in a (sub)view (e.g., total cost of all long-distance calls). In terms of the display of the data, there are fields, which are formatted expressions; grids, which are tabular displays of all of the values of a set of fields; aggregates, which sum or count the columns in a grid; and other entities such as headers, footers, and delimiters, which are largely self-explanatory. There is also a high-level entity called a segment which represents a style of page, e.g., the orientation, paper size, headers, footers, etc. The top-level entity is called a layout, which may contain several segments. In keeping with the document type definition of Appendix B, an exemplary IML file for a simple invoice is set forth in Appendix B.

While various concepts have been described in detail, it will be appreciated by those skilled in the art that various modifications and alternatives to those concepts could be developed in light of the overall teachings of the disclosure. As such, the particular concepts disclosed are meant to be illustrative only and not limiting as to the scope of the invention which is to be given the full breadth of the appended claims and any equivalents thereof.

What is claimed is:

1. A method for specifying an invoice, comprising:
using a first set of IML tags defined by a document type definition to select data for use in the invoice; and
using a second set of IML tags defined by the document type definition to specify a layout for the invoice including the selected data.

2. The method as recited in claim 1, wherein the first set of IML tags comprise a filter.

3. The method as recited in claim 2, wherein the first set of IML tags comprise a grouping filter.

4. The method as recited in claim 3, wherein the first set of IML tags comprise an accumulator.

5. The method as recited in claim 1, wherein the first set of IML tags comprise an expression.

6. The method as recited in claim 1, wherein the second set of IML tags comprise a field.

7. The method as recited in claim 1, wherein the second set of IML tags comprise a grid.

8. The method as recited in claim 1, wherein the second set of IML tags comprise an aggregate.

9. The method as recited in claim 1, wherein the second set of IML tags comprise a segment.

10. The method as recited in claim 1, wherein the second set of tags comprise a layout.

11. The method as recited in claim 1, wherein the second set of tags comprise a header.

12. The method as recited in claim 1, wherein the second set of tags comprise a footer.

13. The method as recited in claim 1, wherein the second set of tags comprise a delimiter.

14. A method for generating an invoice, comprising:
creating an IML file including a first set of IML tags defined by a document type definition that are used to select data for inclusion in the invoice and a second set of IML tags defined by the document type definition that are used to specify a layout for the invoice including the selected data;
providing the IML file to an invoice generating application which accesses a database of a service provider to collect data according to the first set of tags and which uses the collected data and the second set of tags to generate an invoice output file; and
providing the invoice output file to an output device which uses the invoice output file to generate the invoice.

15. The method as recited in claim 14, wherein the invoice output file comprises an HTML file.

16. The method as recited in claim 15, further comprising transmitting the output file via a network to the output device.

17. The method as recited in claim 16, wherein the output device comprises a hand-held processing device.

18. The method as recited in claim 16, wherein the output device comprises a personal computer.

19. The method as recited in claim 14, wherein the invoice output file comprises a printer-control language file.

20. A system for generating an invoice, comprising:
a database having stored thereon data associated with a customer service organization;
an IML file including a first set of IML tags defined by a document type definition that are used to select data for inclusion in the invoice and a second set of IML tags defined by the document type definition that are used to specify a layout for the invoice including the selected data; and
an invoice generating application which accesses the database to collect data according to the first set of tags and which uses the collected data and the second set of tags to generate an invoice output file.

21. The system as recited in claim 20, wherein the invoice output file comprises an HTML file.

22. The system as recited in claim 20, wherein the invoice output file comprises a printer-control language file.
